(19) United States
(12) Patent Application Publication
(10) Pub. No.: US 2021/0214264 A1
(43) Pub. Date: Jul. 15, 2021

(54) ROLLER CONVEYOR FOR TRANSPORTING A PANE

(71) Applicant: SAINT-GOBAIN GLASS FRANCE, COURBEVOIE (FR)

(72) Inventors: Arthur PALMANTIER, Aachen (DE); Achim ZEICHNER, Herzogenrath (DE); Jean Jacques BRIS, Bey (FR); Michael CHARREL, Sermoyer (FR); Alain ROUILLER, Saint Laurent d'Andenay (FR)

(21) Appl. No.: 17/055,036

(22) PCT Filed: May 3, 2019
(86) PCT No.: PCT/EP2019/061362

§ 371 Date: Nov. 12, 2020

(30) Foreign Application Priority Data
May 15, 2018 (EP) 18172373.5

(51) Int. Cl. C03B 35/16; C03B 35/18

(52) U.S. Cl. CPC C03B 35/162; C03B 23/023; C03B 35/184

(57) ABSTRACT

A roller conveyor for transporting a pane along a direction of conveyance, includes a plurality of transport rollers, which are arranged next to one another in the direction of conveyance and have roller ends with bearings arranged thereon, at least one upper cooling device for cooling a set of roller ends, which has an upper surface, an oppositely arranged lower surface, and a circumferentially arranged side surface, wherein the upper cooling device is movable between a first position, in which the upper cooling device is arranged substantially parallel to the axis of rotation of the transport rollers above the set of roller ends for cooling the roller ends and the lower surface of the cooling device is turned toward the set of roller ends, and a second position, in which the upper cooling device is, compared to the first position, upwardly pivoted by the angle α.

The invention relates to a roller conveyor for transporting a pane with at least one cooling device for cooling a set of roller ends of the roller conveyor.

A variety of bending methods for glass panes are described in the patent literature.

WO 2017/178733 A1 describes a bending method, in which the pane is bent in a bending chamber that has a first bending mold and a second bending mold arranged offset laterally thereto. The transport of the pane to be processed into the position below the first bending mold is done via a roller conveyor that comprises a plurality of transport rollers, wherein a row of the roller ends of the transport rollers is arranged within the bending chamber.

Thermal bending methods are usually carried out at temperatures from 650° C. to 700° C. Such high temperatures in the bending chamber can result in problems with the bearings arranged at the roller ends of the roller conveyor used in the thermal bending method, in particular in more rapid wear and damage to the bearings. Such damage can affect processing precision.

WO 2017/078908 A1 discloses a roller conveyor for a bending method in which the roller ends arranged in the bending chamber are cooled by a cooling unit. The cooling chamber of the cooling unit is defined by cans individually arranged around the roller ends and a housing that surrounds the roller ends arranged in the bending chamber.

With the roller conveyor described in WO 2017/078908 A1, changing a roller is associated with great effort. Either the cooling circuit has to be interrupted for this and the upper part of the housing has to be removed in order to be able to remove a transport roller upward together with the can and to be able to insert a new transport roller with a can. Or, the transport roller must be pulled out laterally from the can and a new transport roller then pushed laterally into the can.

The object of the present invention is to provide an improved roller conveyor with at least one cooling device for cooling a set of roller ends of a roller conveyor in which, in particular, a simple replacement of individual transport rollers is possible.

The object of the present invention is accomplished by a roller conveyor according to the independent claim 1. Preferred embodiments emerge from the dependent claims.

A roller conveyor according to the invention for transporting a pane along a direction of conveyance comprises at least:
a plurality of transport rollers, which are arranged next to one another in the direction of conveyance and have roller ends with bearings arranged thereon,
at least one upper cooling device for cooling a set of roller ends, which has an upper surface, an oppositely arranged lower surface, and a circumferentially arranged side surface,

wherein the upper cooling device is movable between a first position, in which the upper cooling device is arranged substantially parallel to the axis of rotation of the transport rollers above the set of roller ends for cooling the roller ends and the lower surface of the cooling device is turned toward the set of roller ends, and a second position, in which the upper cooling device is, compared to the first position, upwardly pivoted by the angle α (alpha).

The bearings can, for example, be arranged directly on the roller ends or be arranged on connectors arranged on the roller ends for connecting the respective roller to the respective bearing.

In one embodiment, the connectors are implemented as end caps, in other words, the bearings are arranged on the end caps arranged on the roller ends.

The roller conveyor according to the invention is preferably a roller conveyor for a pane processing system, in particular a roller conveyor for a bending device, comprising a bending chamber, in which a first bending mold and a bending mold offset laterally thereto are arranged. The roller conveyor according to the invention is preferably suitable for transporting a pane into the bending chamber into a position below the first bending mold, and a row of roller ends of the roller conveyor is arranged in the heated bending chamber. Preferably, all roller ends arranged in the heated bending chamber are cooled by means of the at least one upper cooling device. The roller ends arranged outside the heated bending chamber roller ends are preferably not cooled. The roller ends outside the bending chamber that are arranged near the bending chamber can, if desired, also be cooled. The cooling can, in this case, be done with any suitable cooling system, for instance, by cooling pipes supplying water or another cooling fluid.

The term “lower surface of the upper cooling device” refers, in the context of this application, to the surface of the upper cooling device that, in the first position, faces the set of roller ends. “Upper surface of the upper cooling device” refers, in the context of this application to the surface of the upper cooling device opposite the lower surface. The circumferentially arranged side surface of the upper cooling device extends between the upper surface and the lower surface of the upper cooling device.

The term “pane” refers in particular to a glass pane, preferably a soda lime glass to be thermally tempered.

In a preferred embodiment, the upper cooling device is, in the first position, arranged parallel to the axis of rotation of the transport rollers above the set of roller ends for cooling the roller ends.

Preferably, the angle α is between 30° (degrees) and 180°, particularly preferably 45° to 90°, most particularly preferably 60° to 90°. In a particularly preferred embodiment, the upper cooling device is, in the second position, upwardly pivoted completely; in other words, the angle α is 90°, and the lower surface of the upper cooling device is arranged substantially perpendicular to the axis of rotation of the transport rollers. In another embodiment, the upper cooling device is, in the second position, upwardly pivoted by 180°.

The movability of the upper cooling device is preferably achieved via a joint rod, on which the upper cooling device is pivotably attached. Suitable pivotable attachment possibilities for the upper cooling device are known to the person skilled in the art.

A set of roller ends of the roller conveyor preferably includes two to twenty, particularly preferably four to ten, most particularly preferably six roller ends. However, a set of roller ends can also include only one roller; in this case, the upper cooling device provided for cooling the set of roller ends cools only one single roller end.

The roller conveyor according to the invention has, in contrast to the roller conveyors of the prior art, the advantage that it enables effective cooling of at least one set of roller ends and, at the same time, a simple roller change is possible, since the upper cooling device that cools a roller end of the transport roller to be replaced can be upwardly pivoted for the roller change.

In an advantageous embodiment, the roller conveyor includes at least two, preferably at least four, particularly preferably five to ten, upper cooling devices for cooling, in each case, a set of roller ends, with the upper cooling devices arranged next to one another in the direction of conveyance. A roller conveyor according to the invention can, however, also include more than ten upper cooling devices.

The presence of more than one upper cooling device, wherein each of the upper cooling devices is suitable for cooling, in each case, a set of roller ends, offers the advantage that for replacing one transport roller, only that upper cooling device that cools that set of roller ends that includes the roller end to be replaced has to be upwardly pivoted. Thus, during roller replacement, only the cooling of one set of roller ends is interrupted by the movement of this upper cooling device from the first position into the second position. The other sets of roller ends are further cooled by the other upper cooling devices that can remain in the first position during the replacement of the roller and, consequently, the risk of heat-induced wear of their bearings is reduced.

The transport rollers of a roller conveyor according to the invention are cylindrical rollers and are preferably made of ceramic, in particular a silicate-based ceramic, so-called “fused silica insulating foam”. The bearings arranged on the roller ends either directly or via a connector can be made from a metal or a metal-containing alloy, for example, stainless steel. The connectors optionally arranged on the roller ends, which can, for example, be implemented as end caps, can likewise be made of a metal or a metal-containing alloy, for example, stainless steel. The transport rollers of the roller conveyor form a roller bed for flat accommodation of a pane.

The transport rollers of a roller conveyor according to the invention are, in one embodiment, between 500 mm and 5000 mm long, preferably between 1000 mm and 3000 mm, for example, 2300 mm, and have a diameter between 10 mm and 200 mm, preferably between 30 mm and 100 mm, for example, 50 mm.

The upper cooling device preferably has a substantially platelike shape.

The length of the upper cooling device is adapted to the number and diameter of the roller ends for whose cooling the upper cooling device is intended. With the presence of two or more upper cooling devices, the length of the individual cooling devices is independent of one another, in other words, the individual upper cooling devices can even have different lengths and, thus, cool a different number of roller ends.

The width of the upper cooling device is adapted to the dimensions of the roller ends to be cooled. Preferably, the upper cooling device is at least wide enough that, in the first position, it completely covers the bearings arranged on the roller ends. If the bearings are arranged on connectors arranged on the roller ends, the upper cooling device is at least wide enough that, in the first position, it completely covers the bearings arranged on the roller ends and at least partially, but preferably also completely covers the connectors. If these connectors are implemented as end caps, the upper cooling device is preferably at least wide enough that, in the first position, it completely covers the bearings and the end caps arranged on the roller ends. In the case of the presence of two or more upper cooling devices, the width of the cooling devices is independent of each other, in other words, the upper cooling devices can also have different widths.

The upper cooling device is preferably between 10 mm and 200 mm thick, particularly preferably between 20 mm and 100 mm, for example, 40 mm.

In one embodiment, the upper cooling device has a downward-directed protrusion on the section of the side edge turned away from roller ends in the first position. The upper cooling device thus has, in this embodiment, an L-shaped cross-section.

The at least one upper cooling device can, in principle, be any cooling device suitable for reaching a specific temperature. Preferably, the at least one upper cooling device is a cooling device that is connected to a cooling circuit, by means of which a coolant is routed through the at least one upper cooling device. Preferably, a tube system through which the coolant can be routed runs through the upper cooling device. The coolant can, in particular, be water, which can optionally be mixed with antifreeze.

With the presence of more than one upper cooling device, each individual upper cooling device is preferably connected to a separate cooling circuit, enabling particularly efficient cooling.

In an advantageous embodiment, insulation is arranged on the upper surface of the at least one upper cooling device. The insulation material insulates and protects the cooling device. All known insulation materials are suitable as the insulation material. In particular, refractory materials with high insulation capacity, such as, ceramics, fiber-based materials, or materials based on foamed ceramic are suitable. The insulation can, for example, be bolted to the upper cooling device.

The insulation preferably has an overhang u over the upper cooling device, with the insulation thickened in the region of the overhang in the direction of the transport rollers. The thickening is, in particular, implemented such that the insulation reaches all the way to the transport rollers when the upper cooling device is situated in the first position.

In an advantageous embodiment, the insulation has indentations with a substantially semicircular cross-section in the region of the thickened overhang u. These indentations are, in each case, suitable to partially accommodate a section of a transport roller in the first position. The number of indentations in the insulation corresponds to the number of roller ends that the respective upper cooling device cools in the first position. The partial accommodation of the transport rollers in the indentations of the insulation with arrangement of the upper cooling device in the first position prevents or at least reduces heated air flowing into the intermediate space between the roller ends and the at least one upper cooling device and potentially heating the bearings mounted thereon and the optionally present connectors.

In one embodiment, the region between the insulation and the transport rollers in the first position is implemented as a labyrinth seal.

In one embodiment, the roller conveyor according to the invention also has lower insulation that is arranged below the transport rollers, at least in sections, and has indentations in which a transport roller is partially accommodated in each case. Such lower insulation prevents or at least reduces heated air flowing below the transport rollers in the direction of the roller ends and potentially heating the bearings mounted thereon and the optionally present connectors. All known insulation materials are suitable as material for the lower insulation. In particular, refractory materials with high insulation capacity, such as, ceramics, fiber-based materials, or materials based on foamed ceramic, are suitable.

In one embodiment, the lower insulation is, at the same time, the support for the roller ends.

In one embodiment, the region between the lower insulation and the transport rollers is implemented as a labyrinth seal.

In another embodiment of the roller conveyor according to the invention, the at least one upper cooling device is implemented such that it has indentations with a substantially semicircular cross-section on the lower surface that are, in each case, suitable for partially accommodating a roller end in the first position. Such partial accommodation of the roller ends in the indentations in the lower surface of the upper cooling device enables particularly effective cooling of the roller ends. The number of indentations in the lower surface of the upper cooling device corresponds to the number of roller ends that the respective upper cooling device cools such that one roller end each is partially accommodated in one indentation each.

In an advantageous embodiment of a roller conveyor according to the invention, the roller conveyor has, in addition to at least one upper cooling device, at least one lower cooling device for cooling a set of roller ends, which is arranged substantially parallel to the axis of rotation of the transport rollers below the set of roller ends for cooling the set of roller ends.

Preferably, the at least one lower cooling device is connected to a cooling circuit, by means of which a coolant is routed through the lower cooling device. The at least one lower cooling device can, for example, be formed as one or a plurality of cooling tubes or even platelike. In the case of a platelike lower cooling device, a tube system preferably runs through it, through which the coolant of the cooling circuit can be routed. The coolant can, in particular, be water, which can optionally be mixed with antifreeze.

The at least one lower cooling device can be arranged below a support of the roller ends or, however, be arranged directly below the roller ends and thus serve as a support.

In one embodiment, the at least one lower cooling device has indentations with a substantially semicircular cross-section on the side facing the roller ends and is arranged below the transport rollers such that in each case a roller end is partially accommodated in the indentations. The number of indentations in the lower cooling device corresponds to the number of roller ends that the respective lower cooling device cools such that one roller each is partially accommodated in one indentation each and the respective lower cooling device thus serves as a support for the roller ends that are cooled by the respective lower cooling device.

The number of lower cooling devices can differ from the number of upper cooling devices. A roller conveyor according to the invention can, for example, have more than one upper cooling device, but only a single lower cooling device. In this case, the lower cooling device is preferably implemented such that it cools one set of roller ends that includes as many roller ends as the total of the sets of roller ends that are cooled by means of the total of upper cooling devices.

In another embodiment of a roller conveyor according to the invention, the roller conveyor has, in addition to at least one upper cooling device, at least one side cooling device for side cooling a set of roller ends. This is preferably arranged substantially perpendicular to the axis of rotation of the transport rollers on the side of the roller conveyor for side cooling a set of roller ends.

Preferably, the at least one side cooling device is connected to a cooling circuit, by means of which a coolant is routed through the side cooling device. The at least one side cooling device can, for example, be platelike. In one embodiment, a tube system through which the coolant of the cooling circuit can be routed runs through the at least one side cooling device. The coolant can, in particular, be water, which can optionally be mixed with antifreeze.

The number of side cooling devices can differ from the number of upper cooling devices. Thus, a roller conveyor according to the invention can, for example, have more than one upper cooling device, but only a single side cooling device. In this case, the side cooling device is preferably implemented such that it cools a set of roller ends that includes as many roller ends as the total of the sets of roller ends that are cooled by means of the total of upper cooling devices.

Preferably, a roller conveyor according to the invention has, in addition to the at least one upper cooling device, both at least one lower cooling device and at least one side cooling device.

The upper cooling device, the lower cooling device, and/or the side cooling device are preferably made of stainless steel.

In one embodiment, the roller conveyor according to the invention additionally has a means for moving the upper cooling device between the first position and the second position. Means that are suitable for moving the upper cooling device are known to the person skilled in the art. This means can, for example, be a motor-driven mechanical component or a cylinder. Preferably, the means for moving the upper cooling device between the first position and the second position is a cylinder, in particular a pneumatic cylinder.

The invention also relates to a method for changing a transport roller of a roller conveyor according to the invention, whose roller end is cooled by an upper cooling device, wherein the following steps are carried out in the order indicated:
Moving the upper cooling device arranged above the transport roller to be changed, from the first position into the second position,
Removing the transport roller to be changed,
Inserting a new transport roller into the open position,
Moving the upper cooling device from the second position back into the first position.

The expression “inserting a new transport roller into the open position” means that a new transport roller is inserted into the position which was occupied by the transport roller to be changed before removal of the transport roller to be changed.

The first and the fourth step of the method can be done manually or mechanically. In the case of mechanical movement of the upper cooling device from the first position into the second position, this is done, for example, by means of a motor-driven mechanical component or a cylinder. Preferably, the first step and the fourth step of the method are done by means of a motor with position control or by means of a pneumatic cylinder.

The invention also relates to a bending device, at least comprising a heated bending chamber and a roller conveyor according to the invention.

Preferably, the bending device according to the invention has a bending chamber, in which a first bending mold and a second bending mold offset laterally thereto are arranged. The roller conveyor according to the invention arranged in the bending device is preferably suitable for transporting a pane into the bending chamber into a position below the first bending mold and a row of roller ends of the roller conveyor is arranged in the heated bending chamber. A roller conveyor according to the invention can, however, also be suitable for transporting the pane out of the bending chamber.

In an advantageous embodiment of the bending device according to the invention, the row of roller ends of the roller conveyor that is arranged in the heated bending chamber corresponds to the total of the set of roller ends that are cooled by the at least one upper cooling device and optionally also by at least one lower cooling device and/or the at least one side cooling device. In other words, the roller ends arranged in the heated bending chamber are cooled by the at least one upper cooling device. Optionally, the roller ends arranged in the heated bending chamber are also cooled by at least one lower cooling device and/or at least one side cooling device.

A bending device according to the invention can, for example, be a bending device as disclosed in WO 2017/178733 A1, wherein, instead of the roller conveyor described in WO 2017/178733 A1, a roller conveyor according to the invention is used.

The invention also relates to a method for bending a pane, wherein the pane is transported by means of a roller conveyor according to the invention into a bending chamber heated to bending temperature and the pane is bent in the bending chamber. Preferably, the bending chamber used in this method has a first bending mold and a second bending mold offset laterally thereto and the pane is transported by the roller conveyor according to the invention into the bending chamber into the position below the first bending mold.

Of course, the transport of the pane into the bending chamber also includes the transport of the pane within the bending chamber, in particular into a position below a bending mold.

The invention further extends to the use of a pane bent by means of a bending method according to the invention in vehicles, preferably motor vehicles, trucks, buses, particularly preferably as front, rear, roof, or side window panes in vehicles.

The invention is explained in detail with reference to drawings. The drawings are schematic representations and not true to scale. The drawings in no way restrict the invention. They depict:

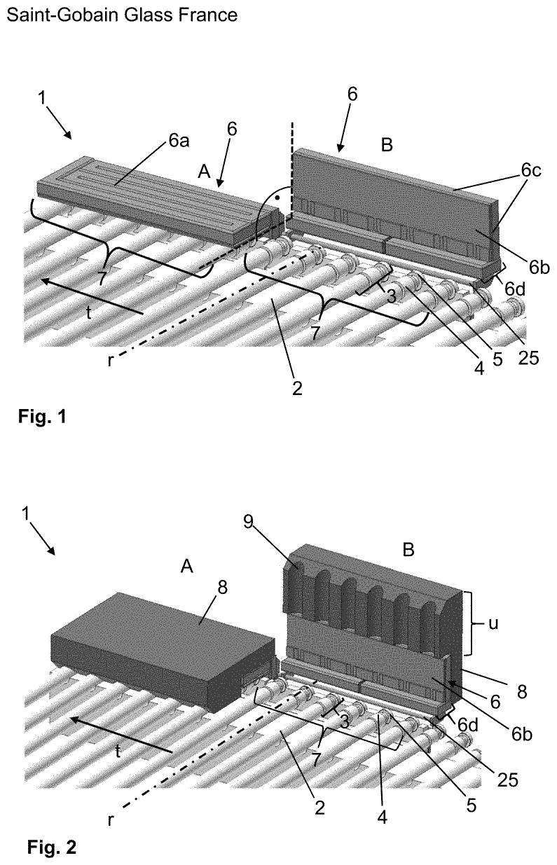

FIG. 1 a perspective representation of a detail of a roller conveyor according to the invention,

FIG. 2 a perspective representation of a detail of another embodiment of a roller conveyor according to the invention,

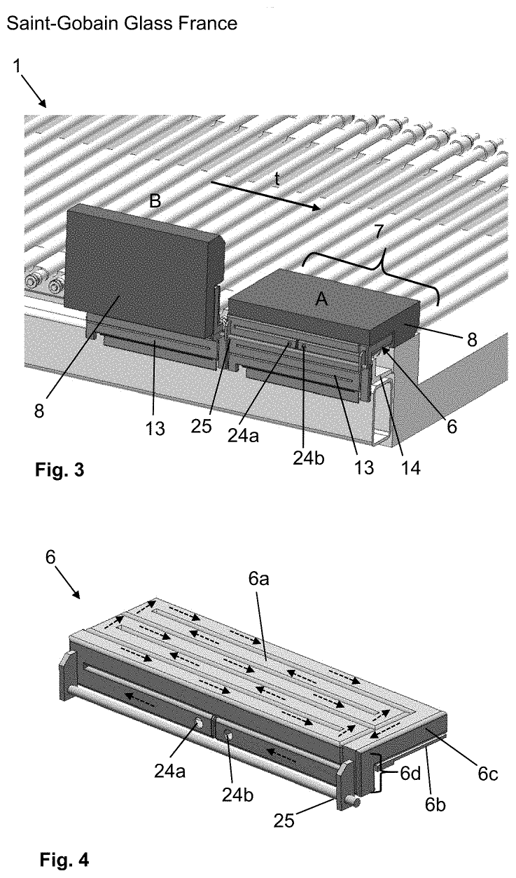

FIG. 3 a perspective representation of a detail of another embodiment of a roller conveyor according to the invention,

FIG. 4 a perspective representation of an upper cooling device,

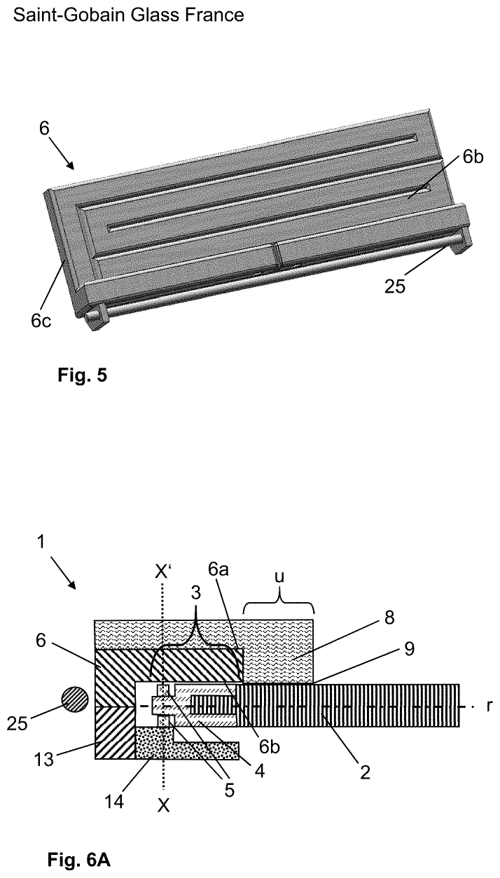

FIG. 5 a perspective representation of an upper cooling device,

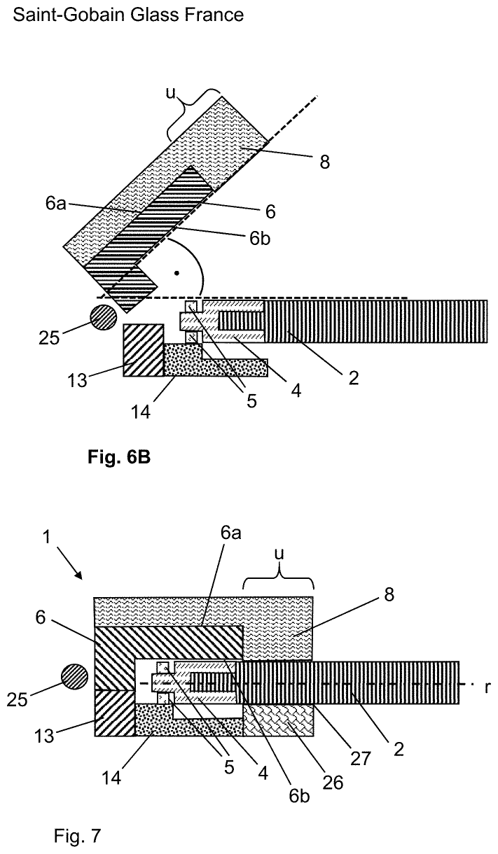

FIG. 6A a detail of a cross-section through a roller conveyor according to the invention in the first position,

FIG. 6B a detail of a cross-section through a roller conveyor according to the invention in the second position,

FIG. 7 a detail of a cross-section through another embodiment of a roller conveyor according to the invention in the first position,

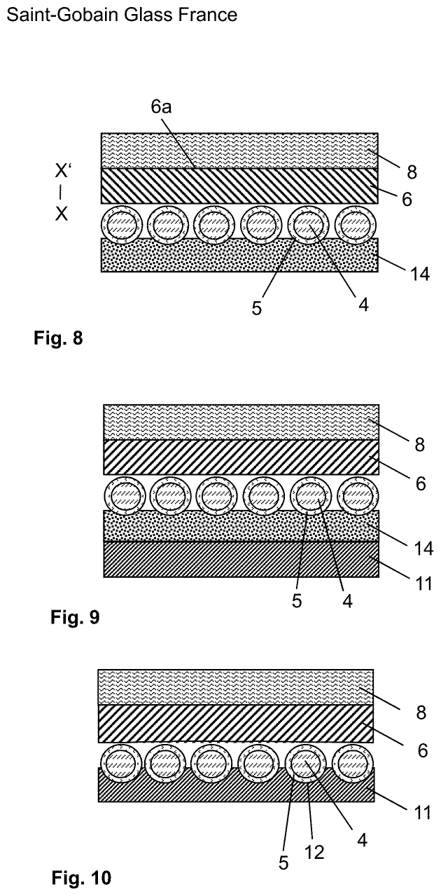

FIG. 8 a detail of a cross-section through an embodiment of a roller conveyor according to the invention along the bearings,

FIG. 9 a detail of a cross-section through another embodiment of a roller conveyor according to the invention along the bearings,

FIG. 10 a detail of a cross-section through another embodiment of a roller conveyor according to the invention along the bearings,

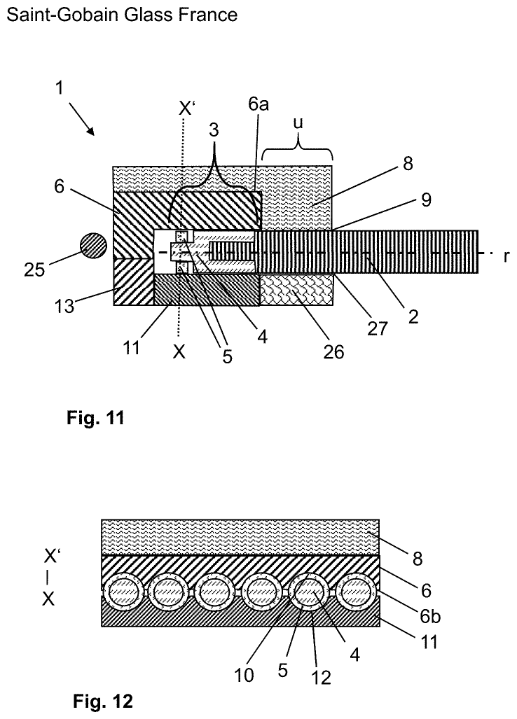

FIG. 11 a detail of a cross-section through another embodiment of a roller conveyor according to the invention in the first position,

FIG. 12 a detail of a cross-section through another embodiment of a roller conveyor according to the invention along the bearings, and

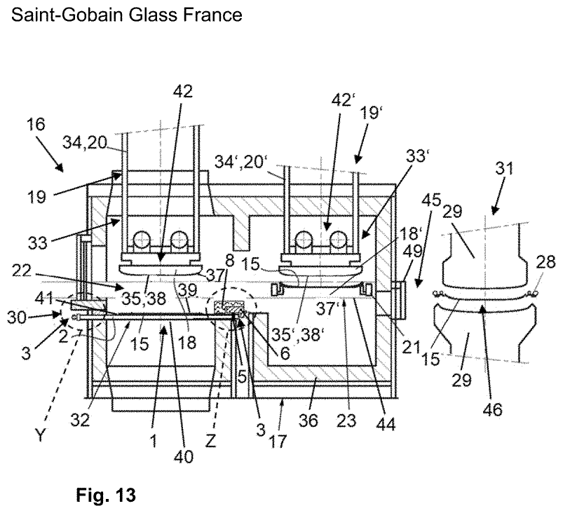

FIG. 13 a schematic representation of a cross-section of an embodiment of a bending device according to the invention.

FIG. 1 depicts a perspective representation of a detail of a roller conveyor 1 according to the invention. A plurality of transport rollers 2 are arranged next to one another in the direction of conveyance t. The transport rollers 2 have roller ends 3, on which connectors in the form of end caps 4 and bearings are arranged in the embodiment depicted in FIG. 1. The transport rollers are made, for example, of ceramic and the end caps 4 and bearing 5 are made, for example, of stainless steel. It is, however, also possible for the bearings 5 to be arranged on the roller ends 3 via another connector as an end cap 4 or directly, in other words, for the transport rollers 2 to have no end caps 4. In the detail depicted in FIG. 1, the roller conveyor 1 comprises two upper cooling devices 6 for cooling in each case a set 7 of roller ends 3. The set 7 of roller ends that are cooled by the two upper cooling devices comprise, in the embodiment depicted in FIG. 1, in each case six roller ends 3. The upper cooling devices 6 have in each case an upper surface 6a, an oppositely arranged lower surface 6b, and a circumferential side surface 6c. In FIG. 1, an upper cooling device 6 is situated in the first position (referenced with A in FIG. 1), in which the upper cooling device 6 is arranged parallel to the axis of rotation r of the transport rollers 2 above the set 7 of roller ends 3 for cooling the roller ends 3. In this first position, the lower surface 6b of the cooling device 6 faces the set 7 of roller ends. The second cooling device 6 depicted in FIG. 1 is situated in the second position (referenced with B in FIG. 1), in which the upper cooling device 6, in comparison with the first position A, is upwardly pivoted by the angle α, wherein in the embodiment depicted in FIG. 1, the angle α is 90°. The two upper cooling devices 6 have a platelike structure, wherein the upper cooling devices 6 have a downward-directed protrusion 6d on the section of the side edge 6c turned away from the roller ends in the first position A. The upper cooling devices 6 thus have, in this embodiment, an L-shaped cross-section. The two upper cooling devices 6 are in each case pivotably attached on a joint rod 25.

FIG. 2 depicts a perspective representation of a detail of another embodiment of a roller conveyor 1 according to the invention. The roller conveyor 1, whose detail is depicted in FIG. 2, differs from the roller conveyor 1, whose detail is depicted in der FIG. 1, only in that insulation 8 is applied in each case on the upper surface 6a of the two upper cooling devices 6. The insulation 8 has in each case an overhang u, wherein the overhang is thickened in the direction of the transport rollers 2 and has six indentations 9 with a substantially semicircular cross-section, which are suited to partially accommodate a transport roller 2 in each case in the first position A.

FIG. 3 depicts a perspective representation of a detail of another embodiment of a roller conveyor 1 according to the invention. The roller conveyor 1, whose detail is depicted in FIG. 3, differs from the roller conveyor 1, whose detail is depicted in FIG. 2, only in that the roller conveyor 1 has two side cooling devices 13, which are implemented platelike. In FIG. 3, in the upper cooling device 6 depicted in the first position A, the coolant inlet 24a and the coolant outlet 24b, via which the upper cooling device 6 can be connected to a cooling circuit, are also depicted. The embodiment of the roller conveyor 1, whose detail is depicted in FIG. 3, has no lower cooling device 11 and the support 14, which supports the bearings 5, is depicted. However, a cooling tube routing cooling water can, for example, also function as a support 14.

FIG. 4 and FIG. 5 are a perspective representation of an upper cooling device 6 from different viewing angles. The upper cooling device 6 depicted in FIGS. 4 and 5 is implemented platelike and has an upper surface 6a, a lower surface 6b, and a circumferential side edge 6c therebetween. The upper cooling device 6 has a protrusion 6d such that the cross-section of the upper cooling device 6 is L-shaped. The coolant inlet 24a and the coolant outlet 24b are also depicted in FIG. 4 and the flow direction of the coolant through the upper cooling device 6 is indicated with arrows. The upper cooling device 6 depicted in FIGS. 4 and 5 is pivotably attached on a joint rod 25.

FIG. 6A depicts a detail of a cross-section through an embodiment of a roller conveyor 1 according to the invention in the first position A. The cross-section runs through a transport roller 2 along its axis of rotation r. An end cap 4, on which a bearing 5 is arranged, is attached on the roller end 3. The end cap 4 is optional; the bearing 5 can be arranged on the roller ends 3 via an alternative connector or even directly. The transport roller 2 is made, for example, of ceramic; and the end cap 4 and the bearing 5 are made of stainless steel. The bearing 5 is positioned on a support 14 and is supported by it from below. The roller end 3 is cooled by an upper cooling device 6, wherein the upper cooling device 6 has an L-shaped cross-section. In the embodiment depicted in FIG. 6A, the upper cooling device 6 completely covers the end cap 4 and the bearing 5 arranged thereon. The upper cooling device is made, for example, of stainless steel and is connected to a cooling circuit not shown in FIG. 6A. The upper cooling device 6 is pivotably attached on a joint rod 25 (attachment not shown in FIG. 6A). Insulation 8, which has an overhang u, is arranged on the upper surface 6a of the upper cooling device 6. In the region of the overhang u, the insulation 8 is thickened in the direction of the transport roller 2. The transport roller 2 is partially accommodated in an indentation 9 in the insulation 8 with a substantially semicircular cross-section. In the embodiment depicted in FIG. 6A, the roller conveyor 1 has a side cooling device 13 that is arranged laterally from the roller end 3. This is made, for example, of stainless steel and is connected to a cooling circuit (not shown in FIG. 6A).

FIG. 6B differs from FIG. 6A only in that the upper cooling device 6 is upwardly pivoted by the angle α.

FIG. 7 depicts a detail of a cross-section through another embodiment of a roller conveyor 1 according to the invention in the first position A. The cross-section runs through a transport roller 2 along its axis of rotation r. The embodiment of the roller conveyor 1 differs from that of the roller conveyor 1 whose cross-section is depicted in FIG. 6A only in that an additional insulation 26 is arranged below the transport roller 2 opposite the overhang u and adjacent the support 14. The insulation 26 has an indentation 27 with a substantially semicircular cross-section, in which the transport roller 2 is partially accommodated. It is also possible for the insulation 26 to additionally even extend below the support 14 (not shown in FIG. 7).

FIG. 8 depicts a detail of a cross-section through a roller conveyor 1 according to the invention along the bearings 5. This corresponds to a cross-section along the section line X′-X of FIG. 6A. The bearings 5 are arranged around the end caps 4 and are supported by the support 14. From above, the bearings 5 and the end caps 4 are cooled by an upper cooling device 6, on whose upper surface 6a insulation 8 is arranged. It is, however, also possible for the bearings 5 to have connectors other than the end caps 4 or to be arranged directly on the roller ends 3, in other words, for the transport rollers 2 to have no end caps 4.

FIG. 9 depicts a detail of a cross-section through another embodiment of a roller conveyor 1 according to the invention along the bearings 5. The embodiment, whose detail of a cross-section is depicted in FIG. 9 differs from the embodiment, whose detail of a cross-section is depicted in FIG. 8 only in that a lower cooling device 11 is arranged below the support 14.

FIG. 10 depicts a detail of a cross-section through another embodiment of a roller conveyor 1 according to the invention along the bearings 5. The embodiment whose detail of a cross-section is depicted in FIG. 10 differs from the embodiment whose detail of cross-section is depicted in FIG. 8 only in that instead of a support 14, a lower cooling device 11 that supports the bearings 5 is arranged below the bearings 5. The lower cooling device 11 has, on the side facing the bearings 5, indentations 12 with a substantially semicircular cross-section, in which the bearings 5 and the end caps 4, i.e., the roller ends 3, are partially accommodated.

FIG. 11 depicts a detail of a cross-section through an embodiment of a roller conveyor 1 according to the invention in the first position A. The cross-section runs through a transport roller 2 along its axis of rotation r. An end cap 4 on which a bearing 5 is arranged is attached on the roller end 3. The end cap 4 is optional; the bearing 5 can also be arranged on the roller end via an alternative connector or directly. The transport roller 2 is made, for example, of ceramic; and the end cap 4 and the bearing 5 are made of stainless steel. The roller end 3 is cooled by an upper cooling device 6, wherein the upper cooling device 6 has an L-shaped cross-section. In the embodiment depicted in FIG. 11, the upper cooling device 6 completely covers the end cap 4 and the bearing 5 arranged thereon. The upper cooling device 6 has, on the lower surface 6b, indentations 10 with a substantially semicircular cross-section, in which the bearings 5 and the end caps 4, i.e., the roller ends 3, are partially accommodated. The upper cooling device 6 is made, for example, of stainless steel and is connected to a cooling circuit, not shown in FIG. 11. The upper cooling device 6 is pivotably attached on a joint rod 25 (attachment not shown in FIG. 11). Insulation 8, which has an overhang u, is arranged on the upper surface 6a of the upper cooling device 6. In the region of the overhang u, the insulation 8 is thickened in the direction of the transport roller 2. The transport roller 2 is partially accommodated in an indentation 9 in the insulation 8 with a substantially semicircular cross-section. In the embodiment depicted in FIG. 11, the roller conveyor 1 has a side cooling device 13 that is arranged laterally from the roller end 3. This is made, for example, of stainless steel and is connected to a coolant circuit (not shown in FIG. 11). A lower cooling device 11 is arranged below the bearings 5 and supports the bearings 5. The lower cooling device 11 has, on the side facing the bearings 5, indentations 12 with a substantially semicircular cross-section, in which the bearings 5 and the end caps 4, i.e., the roller ends 3, are partially accommodated. The roller conveyor 1 has lower insulation 26. The transport roller 2 is partially accommodated in an indentation 27 in the insulation 26 with a substantially semicircular cross-section. The lower cooling device 11 and the side cooling device 13 can also be implemented in one piece in an alternative embodiment.

FIG. 12 depicts a detail of a cross-section through another embodiment of a roller conveyor 1 according to the invention along the bearings 5. This corresponds to a cross-section along the section line X′-X of the FIG. 11. The embodiment whose detail of a cross-section is depicted in FIG. 12 differs from the embodiment whose detail of a cross-section is depicted in FIG. 10 only in that the upper cooling device 6 has, on the lower surface 6b, indentations 10 with a substantially semicircular cross-section, in which the bearings 5 and the end caps 4, i.e., the roller ends 3, are partially accommodated, and in that the embodiment has lower insulation 26, with the insulation not depicted in FIG. 12.

FIG. 13 depicts a simplified schematic representation of an embodiment of a bending device 16 according to the invention in a cross-sectional view. The device 16 comprises a bending zone 17 for bending panes 15, a preheating zone 30 arranged laterally to the bending zone 17 and having a heating device for heating the panes 15 to bending temperature, which is not shown in detail in FIG. 13, since, in the view of the figures, it is situated behind the bending zone 17, as well as a laterally arranged tempering zone 31 for cooling or tempering bent panes 15. The tempering zone 31 is coupled laterally to the right of the bending zone 17. The preheating zone 30 and the tempering zone 31 are arranged, viewed from above, at an angle of 90° to the bending zone 17 and functionally coupled thereto. The preheating zone 30, the bending zone 17, and the tempering zone 31 are, here, in each case spatially separated regions of the device. The bending zone 17 is implemented in the form of a bending chamber closed to the external environment or sealable. For this purpose, the bending zone 17 is provided with an insulating wall 36 such that the interior of the bending zone 17 can be heated to and maintained at a temperature (bending temperature) suitable for a bending operation of the pane 15. The bending zone 17 has, for heating the interior, a heating device, which is not shown in detail in FIG. 13.

The panes 15 can be successively transported into the device 16 from the preheating zone 30 into the bending zone 17, and subsequently into the tempering zone 31. For transport of the panes 15 from the preheating zone 30 into the bending zone 17, a roller conveyor 1 according to the invention is provided, which includes cylindrical transport rollers 2 for the flat support of panes 15. The transport rollers 2 are actively and/or passively rotatably mounted with their horizontally aligned rotational axes, here, for example, parallel to the x-direction. By means of the transport rollers 2, panes 15 heated to bending temperature in the preheating zone 30 can be successively brought in each case individually into a removal position 32 in the bending zone 17. The direction of conveyance for the pane 15 is perpendicular to the plane of the drawing.

The bending zone 17 has two separate bending stations 33, 33′, with a first bending station 33 and a second bending station 33′ arranged spatially offset from one another in the horizontal x-direction. In the description of the two bending stations 33, 33′, the reference characters with “ ′ ” refer in each case to a component of the second bending station 33′, with components of the second bending station also possibly not having “ ′ ”, when this seems appropriate. For simpler reference, all components of the second bending station 33′ are also referred to as “second” components, in contrast to the components of the first bending station 33, which are also referred to as “first” components.

The bending stations 33, 33′ have in each case a vertical mounting bracket 34, 34′ for detachable securing of the bending tool 18, 18′. The mounting brackets 34, 34′ are in each case vertically displaceable by means of a mounting bracket moving mechanism 19, 19′ (not shown in detail). Optionally, the mounting brackets 34, 34′ are also laterally displaceable by the moving mechanism 19, 19′ in each case with at least one horizontal moving component, in particular in a positive or negative x-direction. On the lower end of the mounting brackets 34, 34′, the respective bending tool 18, 18′ is detachably mounted. Each bending tool 18, 18′ has a downward-directed convex contact surface 35, 35′ for the flat placement of a pane 15. With corresponding system pressure, the pane 15 can be bent on the respective contact surface 35, 35′. The two contact surfaces 35, 35′ have, for this purpose, in each case an end or edge outer surface section 37, 37′ and an inner surface section 38, 38′ with surface contours (surface shapes) different from one another, with the inner surface section 38, 38′ completely surrounded (bordered) by the outer surface section 37, 37′.

Besides the mutually different surface contours of an outer surface section 37, 37′ and an inner surface section 38, 38′ of one and the same bending tool 18, 18′, the contact surfaces 35, 35′ of the two bending tools 18, 18′ also have different surface contours. Specifically, the outer surface section 37 of the contact surface 35 of the first bending tool 18 has a surface contour that corresponds to a desired final edge bend, i.e., final bend, in a (for example, strip-shaped) edge region 39 of the pane 15, in other words, enables such a final bend. The end edge region 39 of the pane 15 is adjacent a pane(section)edge 41 arranged perpendicular to the two opposite primary surfaces of the pane. The inner surface section 38 of the contact surface 35 of the first bending tool 18 has a surface contour that corresponds to a surface pre-bend, i.e., non-final bend, in an inner region 40 of the pane 15 completely surrounded by the edge region 39. The outer surface section 37′ of the contact surface 35′ of the second bending tool 18′ has one and the same surface contour as the outer surface section 37 of the contact surface 35 of the first bending tool 18 and has a surface contour that corresponds to the desired final edge bend in the edge region 39 of the pane 15. In contrast to the inner surface section 38 of the contact surface 35 of the first bending tool 18, the inner surface section 38′ of the contact surface 35′ of the second bending tool 18′ has a surface contour that corresponds to a final surface bend, i.e., a final or quasi-final bend, in the inner region 40 of the pane 15. The first mounting bracket 34 forms, together with the first bending tool 18, a first bending mold 20. Correspondingly, the second mounting bracket 34′ forms, together with the second bending tool 18′, a second bending mold 20′.

The two bending stations 33, 33′ are in each case provided with a suction apparatus 42, 42′ for sucking a pane 15 against the contact surface 35, 35′. The contact surfaces 35, 35′ can, for this purpose, for example, be provided with uniformly distributed suction orifices (not shown) and/or an edge skirt. By means of a generated negative pressure or vacuum, a pane 15 can be sucked against the contact surface 35, 35′.

The first bending station 33 further has a blower apparatus 43 (not shown in detail) by means of which a flowing gaseous fluid can be generated, e.g., an air flow 50, vertically through the roller conveyor 1 at the removal position 32. By this means, a pane 15 can be raised from the removal position 32 in the direction of the bending mold 20. The removal position 32 is situated, in the vertical direction, directly below the bending tool 18 of the first bending mold 20.

The bending station 33 further has a press frame 21 (e.g., press ring) for pressing and transporting a pane 15. The press frame 21 is fixedly mounted on an elongated support 44 and can be laterally displaced by moving the support 44 in in the positive and negative x-direction relative to the first and second bending mold 20, 20′. The support 44 can be moved by a support moving mechanism (not shown in detail) along its extension direction. Thus, the press frame 21 can be moved back-and-forth translationally in particular between a first press frame position 22 of the first bending station 33 and a second press frame position 23 of the second bending station 33′. The first press frame position 22 and the second press frame position 23 are situated, here, for example, in the same horizontal plane. The removal position 32 is situated directly below the first press frame position 22.

The press frame 21 has at its edge a (for example, strip-shaped) pressing surface, whose surface contour is complementary to the surface contour of the outer surface 37 of the bending tool 18 of the first bending mold 20. The upward-facing pressing surface is suitable for pressing a pane 15 placed thereon in its edge region 39. The press frame 21 is not designed with a full surface, but instead, has an inward-lying discontinuity, which enables surface pre-bending by gravity of the inner region 40 of a pane 15 placed thereon.

The tempering zone 31 is coupled laterally to the bending zone 17 has two so-called “tempering boxes” 29, which are arranged offset relative to one another in the vertical direction. By means of the two tempering boxes 29, an air flow for air cooling a pane 15 situated between the two tempering boxes 29 can be generated in each case in order to temper the bent pane 15. Situated in the tempering zone 31 is a tempering frame 28 for transporting and holding a bent pane 15 during tempering. The tempering frame 28 can be offset laterally relative to the bending zone 17 by a tempering frame moving mechanism 45 (not shown in detail) along at least one horizontal moving component. Specifically, the tempering frame 28 can be moved translationally back and forth between a second tempering frame position 46, situated between the two tempering boxes 29 of the tempering station 31, and a first tempering frame position 23, identical to the second press frame position. For this purpose, the bending zone 17 implemented as a bending chamber has a door 49. In this manner, the tempering frame 28 can be driven into the second frame position 23 in order to collect a bent pane 15 and transport it into the tempering zone 31. From there, the pane 15 can be removed in a simple manner and further processed.

In FIG. 13, it can be seen that in the case of the transport rollers 2 that transport the pane 15 within the bending chamber 17, in each case one roller end 3 is arranged within the bending chamber 17 (roller end in the region identified with Z) and one roller end 3 is arranged outside the bending chamber 17 (roller end in the region identified with Y). Thus, in the case of the embodiment of a bending device 16 according to the invention depicted in FIG. 13, a row of roller ends 3 is arranged within the bending chamber 17. In order to protect the bearings 3 of the transport rollers 2 against the temperatures from 650° C. to 700° C. prevailing in the bending chamber 17, the bending device according to the invention depicted in FIG. 13 has, in the region identified with Z, an upper cooling device 6 for cooling the roller ends 3 arranged in the bending chamber 17, wherein insulation 8 is arranged on the upper surface of the upper cooling device 5.

### LIST OF REFERENCE CHARACTERS

1 roller conveyor

2 transport roller

3 roller end

4 end cap

5 bearing

6 upper cooling device

6a upper surface

6b lower surface

6c side surface

6d protrusion

7 set (of roller ends)

8 insulation

9 indentation

10 indentation

11 lower cooling device

12 indentation

13 side cooling device

14 mounting bracket

15 pane

16 bending device

17 bending zone, bending chamber

18 first bending tool

19 second bending tool

20,20′ bending mold

21 press frame

22 first press frame position

23 second press frame position

24a coolant inlet

24b coolant outlet

25 joint

26 lower insulation

27 indentation

28 tempering frame

29 tempering box

30 preheating zone

31 tempering zone

32 removal position

33,33′ bending station

34,34′ mounting bracket

35,35′ contact surface

36 insulating wall

37,37′ outer surface section

38,38′ inner surface section

39 edge region

40 inner region

41 pane edge

42,42′ suction apparatus

43 blower apparatus

44 support

45 pressing surface

46 tempering frame moving mechanism

47 second tempering frame position

48 blower apparatus air flow

49,49′ suction apparatus air flow

50 door

51 support moving mechanism

t direction of conveyance

r axis of rotation

u overhang

A first position

B second position

Y region of roller ends outside the bending chamber

Z region of roller ends in the bending chamber

1. A roller conveyor for transporting a pane along a direction of conveyance, comprising:
a plurality of transport rollers, which are arranged next to one another in the direction of conveyance and have roller ends with bearings arranged thereon,
at least one upper cooling device for cooling a set of roller ends, which has an upper surface, an oppositely arranged lower surface, and a circumferentially arranged side surface,
wherein the upper cooling device is movable between a first position, in which the upper cooling device is arranged substantially parallel to an axis of rotation of the transport rollers above the set of roller ends for cooling the roller ends and the lower surface of the cooling device is turned toward the set of roller ends, and a second position, in which the upper cooling device is, compared to the first position, upwardly pivoted by an angle α.

2. The roller conveyor according to claim 1, wherein the angle α is between 30° and 180°.

3. The roller conveyor according to claim 1, wherein the at least one upper cooling device is connected to a cooling circuit, by means of which a coolant is routed through the at least one upper cooling device, wherein the coolant is water.

4. The roller conveyor according to claim 1, wherein insulation is arranged on the upper surface of the at least one upper cooling device.

5. The roller conveyor according to claim 4, wherein the insulation has, over the upper cooling device, an overhang thickened in a direction of the transport rollers and the insulation has, in a region of the overhang, indentations with a substantially semicircular cross-section, which are in each case suitable for partially accommodating, in the first position, a section of a transport roller, and a number of indentations corresponds to a number of roller ends cooled by the upper cooling device.

6. The roller conveyor according to claim 1, wherein, at least in sections, lower insulation is arranged below the transport rollers, which has indentations, in which in each case a transport roller is partially accommodated.

7. The roller conveyor according to claim 1, wherein the at least one upper cooling device has, on the lower surface, indentations with a substantially semicircular cross-section, which are in each case suitable for partially accommodating, in the first position, a roller end, and a number of indentations corresponds to a number of roller ends cooled by the upper cooling device.

8. The roller conveyor according to claim 1, wherein a set of roller ends comprises two to twenty roller ends.

9. The roller conveyor according to claim 1, wherein at least two upper cooling devices for cooling in each case a set of roller ends are arranged next to one another in the direction of conveyance.

10. The roller conveyor according to claim 1, additionally comprising at least one lower cooling device for cooling a set of the roller ends, which is arranged substantially parallel to the axis of rotation of the transport rollers below the set of roller ends for cooling the set of roller ends and is connected to a cooling circuit, by means of which a coolant is routed through the lower cooling device wherein the coolant is water.

11. The roller conveyor according to claim 10, wherein the at least one lower cooling device has, on a side facing the transport rollers, indentations with a substantially semicircular cross-section, a number of indentations corresponds to a number of roller ends cooled by the lower cooling device, and the lower cooling device is arranged below the transport rollers such that the roller ends to be cooled by the lower cooling device are likewise partially accommodated in the indentations.

12. The roller conveyor according to claim 1, additionally comprising at least one side cooling device for side cooling a set of roller ends, which at least one side cooling device is connected to a cooling circuit, by means of which a coolant is routed through the side cooling device, wherein the coolant is water.

13. A method for changing a transport roller of a roller conveyor according to claim 1, whose roller end is cooled by an upper cooling device, the method comprising:
moving the upper cooling device arranged above the roller end of the transport roller to be changed from the first position into the second position,
removing the transport roller to be changed,
inserting a new transport roller into the open position,
moving the upper cooling device from the second position back into the first position.

14. A bending device, comprising a heated bending chamber and a roller conveyor according to claim 1 for transporting a pane into the bending chamber.

15. A method for bending a pane, comprising transporting the pane by means of a roller conveyor according to claim 1 into a bending chamber heated to bending temperature and bending the pane in the bending chamber.

16. The roller conveyor according to claim 2, wherein the angle α is from 45° to 90°.

17. The roller conveyor according to claim 16, wherein the angle α is 90°.

18. The roller conveyor according to claim 8, wherein the set of roller ends comprises four to ten roller ends.

19. The roller conveyor according to claim 9, wherein at least four upper cooling devices for cooling in each case a set of roller ends are arranged next to one another in the direction of conveyance.

20. The roller conveyor according to claim 19, wherein five to ten upper cooling devices for cooling in each case a set of roller ends are arranged next to one another in the direction of conveyance.
